(19) United States
(12) Patent Application Publication
(10) Pub. No.: US 2016/0013510 A1
(43) Pub. Date: Jan. 14, 2016

(54) BUBBLE BATTERY SYSTEM

(71) Applicant: DENSO International America, Inc., Southfield, MI (US)

(72) Inventor: Patrick Powell, Farmington Hills, MI (US)

(21) Appl. No.: 14/326,723

(22) Filed: Jul. 9, 2014

(51) Int. Cl. H01M 10/04; B60L 11/18; H02J 7/02; H01M 10/46; H02J 5/00

(52) U.S. Cl. CPC H01M 10/0413; H01M 10/46; H02J 5/005; H02J 7/025; B60L 11/1809; H01M 2220/20

(57) ABSTRACT

A battery system includes a plurality of rechargeable micro-batteries, fluid media, a battery media tank, a power extractor, and an electric load. The micro-batteries are immersed in the fluid media. The tank stores the fluid media and the micro-batteries. The power extractor is fluidly connected to the tank and extracts electric power charged inside the micro-batteries while the fluid media and the micro-batteries flow through the power extractor. The electric load is electrically connected to the power extractor and powered by the electric power extracted by the power extractor.

### TECHNICAL FIELD

The present disclosure relates to a battery system having a plurality of micro-batteries.

### BACKGROUND

Generally, the performance of electric and hybrid vehicles is limited by the drawbacks of conventional battery technology. Conventional batteries, such as Li-ion batteries, face several significant challenges in terms of performance within the areas of capacity, charging time, cycling life, cost, etc. For instance, several hours are needed to fully charge the type of battery currently used in electric vehicles. Further, as an example of another drawback, the battery pack of an electric or hybrid vehicle is designed with 50% over-capacity. Such over-capacity cannot be directly used but is held in reserve to accommodate anticipated battery capacity degradation over the life of the vehicle. As a result, such over-capacity significantly increases the weight of the battery pack and reduces the driving range of the vehicle. Even further, when designing the battery pack for electric and hybrid vehicles, significant engineering resources are required to design a battery pack that has a customized size and shape. As a result, generally, batteries packs are vehicle-specific and cannot be shared between vehicles. Moreover, the battery pack may also require sophisticated cooling systems, which further increases the overall cost of battery pack development. A need, therefore, exists for a battery system that addresses the drawbacks of conventional battery technology.

### SUMMARY

It is an objective of the present disclosure to provide a battery system that reduces charging time and overcomes the disadvantages due to battery capacity degradation.

In an aspect of the present disclosure, a bubble battery system includes a plurality of micro-batteries, fluid media, a battery media tank, a power extractor, and an electric load. Each micro-battery is repeatedly rechargeable and the fluid media immerses the micro-batteries. The tank stores the fluid media and the micro-batteries. The power extractor is fluidly connected to the tank and extracts electric power that is stored inside the micro-batteries while the fluid media and the plurality of micro-batteries flow through the power extractor. The electric load is electrically connected to the power extractor and driven by the electric power extracted by the power extractor.

Accordingly, the electric power is discharged from the micro-batteries while the fluid media and the micro-batteries flow through the extractor. After the micro-batteries are discharged, the discharged micro-batteries within the fluid media may be removed and replaced with fluid media that contains fully charged micro-batteries. Similar to refilling a fuel tank of a vehicle with gasoline or changing a vehicle's engine oil, discharged micro-batteries may be quickly replaced relative to the time required to fully charge a conventional battery pack of an electric or hybrid vehicle.

Further, individual damaged micro-batteries or micro-batteries that have reached their serviceable life may be individually replaced with new micro-batteries. As a result, the bubble battery system may be designed with far less over-capacity compared to a conventional battery pack. Thus, the total weight and size of the bubble battery system may be reduced, which increases driving range and decreases cost.

### BRIEF DESCRIPTION OF THE DRAWINGS

The disclosure, together with additional objectives, features and advantages thereof, will be best understood from the following description, the appended claims and the accompanying drawings, in which:

FIG. 1 is a block diagram illustrating a bubble battery system according to a present embodiment;

FIG. 2 is a cross-sectional view of an individual micro-battery;

FIG. 3A is a perspective view of a power extractor;

FIG. 3B is a cross-sectional view of the power extractor;

FIG. 4 is a schematic diagram illustrating an electric vehicle and a refilling device;

FIG. 5 is a block diagram illustrating plug-in recharging of the bubble battery system;

FIG. 6 is a schematic diagram illustrating outboard recharging of the electric vehicle;

FIG. 7 is a block diagram schematically illustrating the outboard recharging of the bubble battery system; and

FIG. 8 is a bubble battery system according to a modification of the present embodiment.

### DETAILED DESCRIPTION

The bubble battery system according to the present embodiment will be described with reference to the drawings. The following description is merely exemplary in nature and is not intended to limit the present disclosure, application, or uses. It is to be noted that, in the present embodiment, the bubble battery system is applied to an electric vehicle.

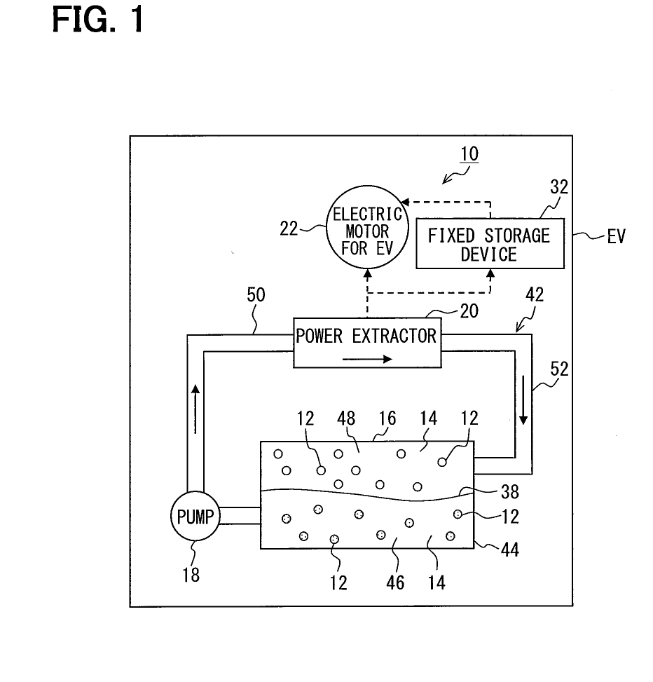

FIG. 1 shows a schematic configuration of the bubble battery system 10 of the present embodiment. The bubble battery system 10 includes a plurality of micro-batteries 12, an inert fluid 14 (i.e., fluid media), a tank 16, a pump 18, a power extractor 20, and an electric motor 22 (i.e., electric load). The bubble battery system 10 draws electric power contained within the micro-batteries 12 and uses the electric power to power the electric motor 22 and the electric vehicle EV. The bubble battery system 10 also includes a fixed storage device 32 that is installed on the electric vehicle EV. The fixed storage device 32 may be a battery or a capacitor that stores excess electric power and minimizes (i.e., absorbs) power surges produced by the power extractor 20. Further, the fixed storage device 32 may also be discharged such that the stored electric power may be used to power the electric motor 22. Moreover, the electric power that is stored in the fixed storage device 32 may be used to power auxiliary vehicle systems and/or devices.

### (Micro-Battery)

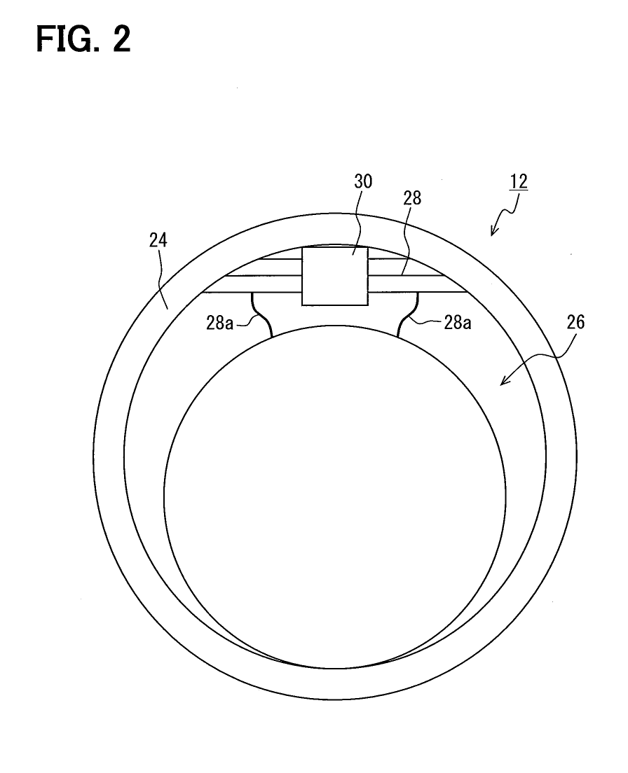

In the present embodiment, each micro-battery 12 is a self-contained battery that may be repeatedly charged and discharged. As illustrated in FIG. 2, the micro-battery 12 includes a battery shell 24, a battery portion 26, a first power transfer 28, and a battery magnet 30 (i.e., first alignment part).

The battery shell 24 is made from a non-conductive material (i.e., an electric insulator) such as plastic. The battery shell 24 has a spherical shape that defines the external shape of the micro-battery 12. It should be understood to one of ordinary skill in the art that the shape of the battery shell 24 is not limited to only spherical shapes and may be formed in other shapes such as an ovular shape or the like. An inner liner (not shown) is provided within the battery shell 24 and covers an inner wall of the battery shell 24 to create a seal between an inside and an outside of the battery shell 24. The battery shell 24 seals air inside the battery shell 24, which may allow the micro-battery 12 to be buoyant in the inert fluid 14.

The battery portion 26 is enclosed inside the battery shell 24 and stores an electrical charge. Similar to a Li-ion rechargeable battery, the battery portion 26 is a rechargeable battery that may be repeatedly discharged and charged. However, it should be understood to one of ordinary skill in the art that the battery portion 26 is not limited to only Li-ion rechargeable battery technology and may include other electricity storage technologies.

The battery portion 26 may be recharged using wireless power transmission such as resonant magnetic induction. The first power transfer 28 may be a coil that wirelessly receives and/or transfers electric power. Through the first power transfer 28, the electric power may be charged into the micro-battery 12 from the power extractor 20 or discharged to the power extractor 20 from the micro-battery 12. The first power transfer 28 is attached to the inner wall of the battery shell 24 and electrically connected to the battery portion 26 by conductive wires 28a. Therefore, during recharging, electricity that is wirelessly received by the first power transfer 28 may be transferred to the battery portion 26. Similarly, during discharging, electricity stored in the battery portion 26 may be transferred from the battery portion 26 and discharged through the first power transfer 28.

The battery magnet 30 is positioned in the center of the first power transfer 28 (i.e., the center of the coil) and is attached to the inner wall of the battery shell 24. The battery magnet 30 is magnetized to have, for example, an S-pole to attract an extractor magnet 56 of the power extractor 20 as described below. The battery magnet 30 is configured to align the micro-battery 12 so that the micro-battery 12 can be in a position with respect to the extractor magnet 56 such that the electric power may transfer between the micro-battery 12 and the power extractor 20.

### (Inert Fluid)

The inert fluid 14 may be a liquid such as water, hydraulic fluid, or the like. In other words, a liquid having inert properties may be adopted as the inert fluid 14. Water may be preferred as the inert fluid 14 in terms of cost-effectiveness and availability. As shown in FIG. 1, the inert fluid 14 is filled with the micro-batteries 12 and acts as a fluid media for carrying the micro-batteries 12. That is, the micro-batteries 12 are immersed in the inert fluid 14. As described below, the inert fluid 14 is circulated in a fluid circulation path 42 by the pump 18. The inert fluid 14 constitutes a power fluid together with the micro-batteries 12.

Further, the inert fluid 14 may serve as a heat transfer media (i.e., heat exchanger) for the micro-batteries 12. The inert fluid 14 exchanges heat generated in the micro-batteries 12 and cools the micro-batteries 12 by exchanging the heat. The heat exchanged by the inert fluid 14 may be used for heating a cabin room, for example.

### (Tank)

The tank 16 includes an exterior body 44 having an inside space and a separator 38 separating the inside space of the exterior body 44 into two volumes, as shown in FIG. 1. The exterior body 44 may be made from a plastic (e.g., high-density polyethylene) or a metal material. That is, the material of the exterior body 44 may be similar to the materials used in the construction of fuel tanks for gasoline or diesel powered vehicles. Further, similar to the fuel tanks of gasoline or diesel powered vehicles, the exterior body 44 may be molded to have a shape designed according to the packaging constraints of the vehicle.

The separator 38 divides the inside space of the exterior body 44 into a powered space 46 and a depowered space 48. The powered space 46 stores charged micro-batteries 12. On the other hand, the depowered space 48 stores discharged micro-batteries 12. The separator 38 is formed as a semipermeable membrane that allows the inert fluid 14 to pass between the powered space 46 and the depowered space 48. However, micro-batteries 12 cannot pass through the separator 38. As such, the inert fluid 14 flowing into the depowered space 48 is allowed to pass through the separator 38 and collect into the powered space 46 such that the inert fluid 14 may be reused. Further, the separator 38 may be flexible to adjust to the changing volumes of charged and discharged micro-batteries 12 within the powered space 46 and the depowered space 48. Even further, the depowered space 48 may be positioned above the powered space 46 since discharged micro-batteries 12 may be more buoyant than charged micro-batteries 12. As a result, the positioning of the powered space 46 and the depowered space 48 may accommodate the difference in buoyancies of the charged and discharged micro-batteries 12. Further, the difference in buoyancies may be used to sort and transfer the charged and discharged micro-batteries 12.

The powered space 46 is fluidly connected to the power extractor 20 through an upstream pipe 50 and the depowered space 48 is fluidly connected to the power extractor 20 through a downstream pipe 52. The upstream pipe 50 and the downstream pipe 52 constitute the fluid circulation path 42 for the power fluid.

### (Pump)

The pump 18 is fluidly connected to the upstream pipe 50 and positioned between the power extractor 20 and the tank 16. The pump 18 suctions the power fluid within the powered space 46 and supplies the power fluid to the power extractor 20. The pump 18 is controlled by a controller (not shown) and the controller adjusts a supply flow rate of the power fluid from the pump 18 according to a power demand of the vehicle (e.g., an acceleration amount requested by a driver). That is, the controller controls the pump 18 to increase the supply flow rate of the power fluid as the power demand of the vehicle increases.

### (Power Extractor)

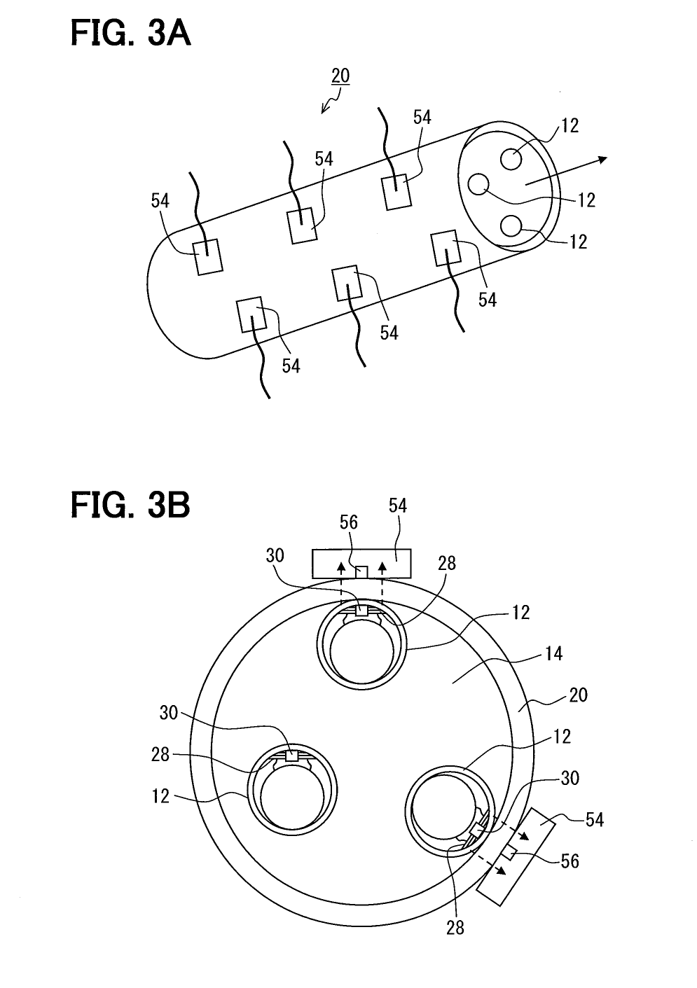

As shown in FIG. 3A, the power extractor 20 has a cylindrical shape and allows the power fluid to flow through an inside of the power extractor 20. The power extractor 20 is fluidly connected to the upstream pipe 50 on an upstream side of the power extractor 20 and to the downstream pipe 52 on a downstream side of the power extractor 20. Further, the power extractor 20 is electrically connected to the electric motor 22.

A plurality of second power transfers 54 are attached on an outer surface of the power extractor 20. The second power transfers 54 are arranged at substantially equal intervals and positioned entirely on the outer surface of the power extractor 20. Each second power transfer 54 may be a coil that wirelessly transfers the electric power. The second power transfer 54 receives and/or transfers the electric power using the wireless transmission technology to/from the first power transfer 28.

When the micro-battery 12 discharges, the second power transfer 54 receives the electric power from the micro-battery 12 through the first power transfer 28. Whereas, when the micro-battery 12 charges, the second power transfer 54 transfers the electric power into the micro-battery 12 through the first power transfer 28.

Each second power transfer 54 has an extractor magnet 56 (i.e., second alignment part). The extractor magnet 56 is positioned in the center of the second power transfer 54 (i.e., the center of the coil) and attached to the outer wall of the power extractor 20. The extractor magnet 56 is magnetized to have a pole opposite to that of the battery magnet 30 (i.e., an N-pole in the present embodiment). Thus, the extractor magnet 56 and the battery magnet 30 are magnetically attracted to each other. As shown in FIG. 3B, the micro-battery 12 aligns with respect to the second power transfer 54 by the magnetic attraction such that the first power transfer 28 and the second power transfer 54 face each other. With this, although the micro-battery 12 flows through the power extractor 20, the micro-battery 12 can be attracted toward the second power transfer 54 and the electric power contained within the micro-battery 12 can be discharged from the first power transfer 28 to the second power transfer 54. That is, the electric power of each micro-battery 12 is extracted by the power extractor 20.

As described above, the electric power of each micro-battery 12 is extracted by the power extractor 20 while the power fluid flows through the power extractor 20. When the power fluid passes through the power extractor 20, the electric power of each micro-battery 12 is fully extracted and the discharged micro-batteries 12 are stored in the depowered space 48.

### (Electric Motor)

The electric motor 22 functions as an electric load powered by the bubble battery system 10. The electric motor 22 is electrically connected to the power extractor 20 and the electric power extracted by the power extractor 20 is supplied to the electric motor 22. The electric vehicle EV is propelled by the electric motor 22 powered by the electric power supplied from the power extractor 20.

It should be noted that the electric power extracted by the power extractor 20 may be stored in the fixed storage device 32. The electric power stored in the fixed storage device 32 is available at any time. For example, the electric power stored in the intermediary onboard battery can be used to power auxiliary vehicle systems or devices when power is not being extracted by the power extractor 20.

### (Refilling the Power Fluid)

The bubble battery system 10 provides for the refilling of the power fluid (i.e., the micro-batteries 12). More specifically, the power fluid stored in the depowered space 48 of the tank 16 that contains the discharged micro-batteries 12 may be removed. Then, new power fluid that contains the fully charged micro-batteries 12 is refilled into the powered space 46 of the tank 16. In other words, the power fluid that has already been discharged can be replaced with the power fluid that is fully charged.

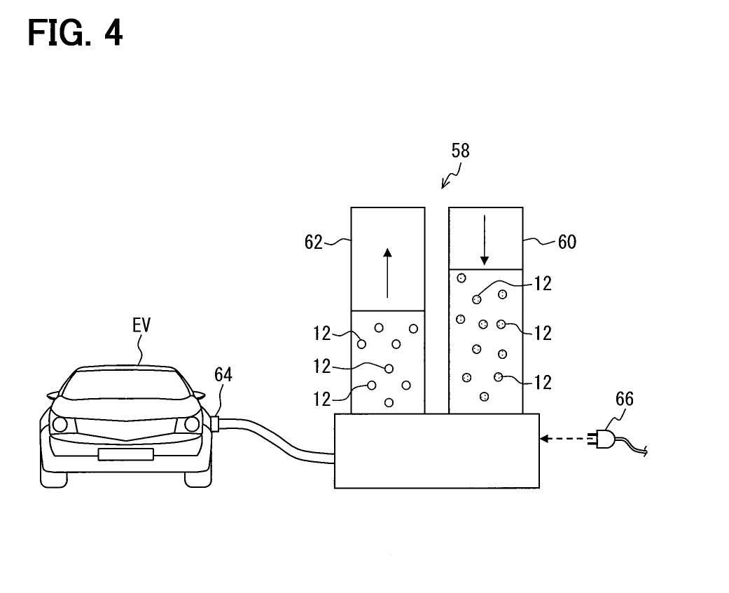

For refilling the power fluid, a refilling device 58 may be used in a manner illustrated in FIG. 4. The refilling device 58 includes a charged container 60, a discharged container 62, and an inlet/outlet nozzle 64. The charged container 60 stores the power fluid that is fully charged and the discharged container 62 stores the power fluid that is discharged. The inlet/outlet nozzle 64 may be fluidly connected to the tank 16 to suction the discharged power fluid stored in the depowered space 48 of the tank 16. Further, the inlet/outlet nozzle 64 supplies the power fluid stored in the charged container 60 into the powered space 46 of the tank 16. That is, after removing the power fluid from the depowered space 48, new power fluid is refilled into the powered space 46 and the bubble battery system 10 is recharged.

In addition, the refilling device 58 may be connected to an external power source 66, as shown in FIG. 4. As such, electric power supplied by the external power source 66 may be used to recharge the discharged micro-batteries 12 stored in the discharged container 62 of the refilling device 58. In other words, the refilling device 58 may charge the discharged micro-batteries 12 in the discharged container 62 such that the discharged micro-batteries 12 are fully-charged. The discharged micro-batteries 12 in the discharged container 62 may be charged via a wireless power transmitter or by flowing the discharged micro-batteries 12 through a power extractor of the refilling device 58. When the power fluid in the discharged container 62 is fully recharged, the recharged power fluid in the discharged container 62 may then be transferred to the charged container 60 and stored therein. Therefore, the micro-batteries 12 are reusable, thereby reducing the environmental impact of the bubble battery system 10.

Similar to gas stations along side of the road, the refilling device 58 may be installed at a commercial facility such that power fluid is readily available to consumers. The refilling device 58 may be also installed in a home for personal use. Further, the refilling device 58 may be integrated with alternative or renewable energy systems (e.g., solar, wind, geothermal, hydroelectric, etc.) to reduce energy costs and environmental impact.

### (Onboard Charging)

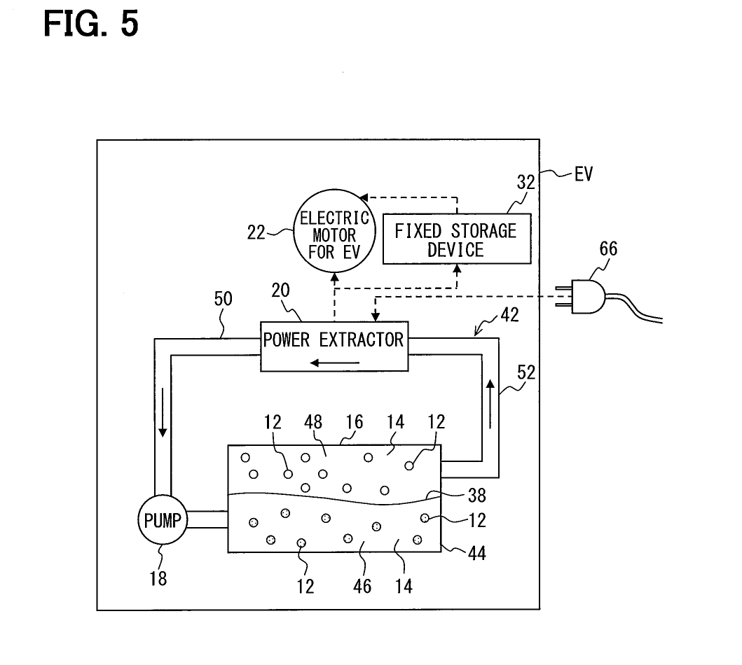

The bubble battery system 10 may be also charged without refilling the power fluid through the refilling device 58. As shown in FIG. 5, the micro-batteries 12 can be directly recharged by electrically connecting the power extractor 20 with an external power source 66. In other words, the bubble battery system 10 can be recharged by plug-in charging (i.e., onboard charging). An existing home power supply or a commercial power source installed in an existing fuelling station can be used as the external power source 66.

For example, as shown in FIG. 5, when the bubble battery system 10 is recharged by plug-in charging, the pump 18 is driven such that the power fluid flows through the fluid circulation path 42 in an opposite direction from the depowered space 48 to the powered space 46 of the tank 16. The first power transfer 28 receives the electric power transferred from the second power transfer 54 while the power fluid flows through the power extractor 20. With this, the micro-batteries 12 are directly recharged without refilling the power fluid.

### (Outboard Charging)

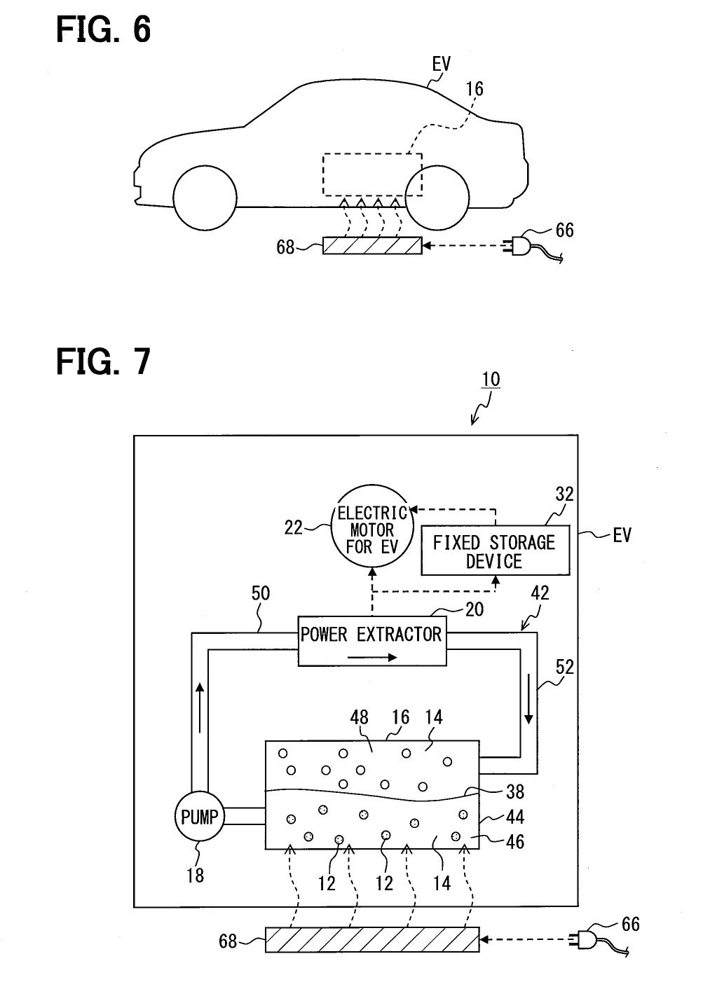

The bubble battery system 10 may also include a wireless power transmitter 68 that is located outboard of the electric vehicle EV for charging the micro-batteries 12. As shown in FIG. 6, the wireless power transmitter 68 is positioned beneath (i.e., externally adjacent to) the tank 16 of the electric vehicle EV. As shown in FIG. 7, the wireless power transmitter 68 may be connected to the external power source 66 such that the micro-batteries 12 may be wirelessly recharged. The wireless power transmitter 68 may be installed over a parking spot of the electric vehicle EV, for example, in the garage of a residential home.

### (Effects of the Present Embodiment)

(1) According to the bubble battery system 10 in the present embodiment, the electric vehicle EV does not depend on a conventional battery that is fixed to the vehicle. That is, when the bubble battery system 10 is discharged, the electric vehicle EV can replace the micro-batteries 12 discharged with those charged by refilling the power fluid. Therefore, vehicle performance such as range, fuel consumption, or the like, can be increased as battery capacity of each micro-battery 12 improves according to advancements in micro-battery technology (i.e., batteries smaller in size and having higher energy density). In other words, as micro-batteries become smaller and capacity improves over time, vehicle performance will also improve. As a result, the bubble battery system 10 can use newly developed and higher capacity micro-batteries 12. Thus, an owner may not feel the need to replace a bubble battery powered electric vehicle EV as often (i.e., relative to conventional gasoline, hybrid, or electric vehicles), which expands the usable life of the vehicle. This is in contrast to conventional gasoline, hybrid, or electric vehicles, where the relative performance of the vehicle is fixed or diminishes relative to advancements in vehicle technology.

(2) The discharged micro-batteries 12 can be replaced with the micro-batteries 12 that are fully charged by refilling the power fluid through the refilling device 58. Therefore, the power fluid can be refilled in minutes, similar to petroleum-based fuels such as gasoline. Thus, in contrast to the amount of time required to charge a conventional electric vehicle, a bubble battery powered electric vehicle EV may be charged quickly.

Further, the bubble battery system 10 can be charged while onboard the electric vehicle EV by using existing battery charging technology (i.e., plug-in charging). Therefore, the bubble battery system 10 can be charged while the electric vehicle EV is not used. For example, the electric vehicle EV (i.e., the bubble battery system 10) can be charged using a home power source during night time hours when electricity costs are low.

Even further, the refilling device 58 may be used as a home energy storage device that charges the micro-batteries 12 using low or no cost energy sources. As such, the amount of power purchased at peak hours (i.e., highest cost) is reduced. Moreover, excess energy stored by the refilling device 58 may be sold back to the power grid.

(3) Batteries currently used in electric vehicle EVs are designed with up to 50% over-capacity to accommodate for battery capacity degradation over time. Thus, the weight and the size of conventional batteries are increased, resulting in reducing the driving range and increasing the cost. However, since the bubble battery system 10 can replace old micro-batteries 12 with newer micro-batteries 12 and no consideration of the battery capacity degradation is needed, each micro-battery 12 need not be designed with over-capacity. Thus, the weight and the size of the total micro-batteries 12 can be decreased compared to conventional batteries, which can increase the driving range and decrease cost.

Further, energy density of the power fluid can increase according to the number of micro-batteries 12 inside the power fluid. Therefore, the energy density of the bubble battery can be higher than conventional batteries by increasing a number of the micro-battery 12 per unit amount of the power fluid.

(4) As described above, the bubble battery system 10 transfers the electric power between the micro-batteries 12 and the power extractor 20 by wireless transfer technology. Therefore, copper wiring is not needed to connect the micro-batteries 12 and the power extractor 20, and thus, the amount of the copper wiring used in the bubble battery system 10 can be reduced, resulting in decreased environmental costs.

(5) The inert fluid 14 acts as a heat dissipation mechanism to cool the micro-batteries 12. Therefore, there is no need for a separate cooling fluid to cool the micro-batteries 12. Further, heat extracted from the micro-batteries 12 may be used to heat the interior cabin of the electric vehicle EV.

In the present embodiment, water is adopted as the inert fluid 14. Since water has non-explosive and non-toxic properties, damage to the vehicle is unlikely to occur even if the bubble battery system 10 is damaged.

(6) The fluid properties of the inert fluid 14 and the small size of the micro-battery 12 allow flexibility in the design of the tank 16. Therefore, the bubble battery system 10 may be used with a variety of vehicles, i.e., the tank does not have shape constraints as compared with conventional batteries. Further, with the design flexibility, the shape of the tank 16 may be molded to improve the safety of the bubble battery system 10.

(7) Since each micro-battery 12 has the battery shell 24 covering the battery portion 26, each micro-battery 12 independently exists in the inert fluid 14 without any metal contact with other components. Therefore, in the event of an accident when one or more micro-batteries 12 are damaged, the damage is contained within the battery shell resulting in minimal impact on other undamaged micro-batteries 12 or components. Further, the damaged micro-batteries 12 can be easily removed from the electric vehicle EV by emptying the tank 16 of the existing damaged and undamaged micro-batteries 12 and refilling the tank 16 with only undamaged micro-batteries 12.

### Modifications to Embodiment

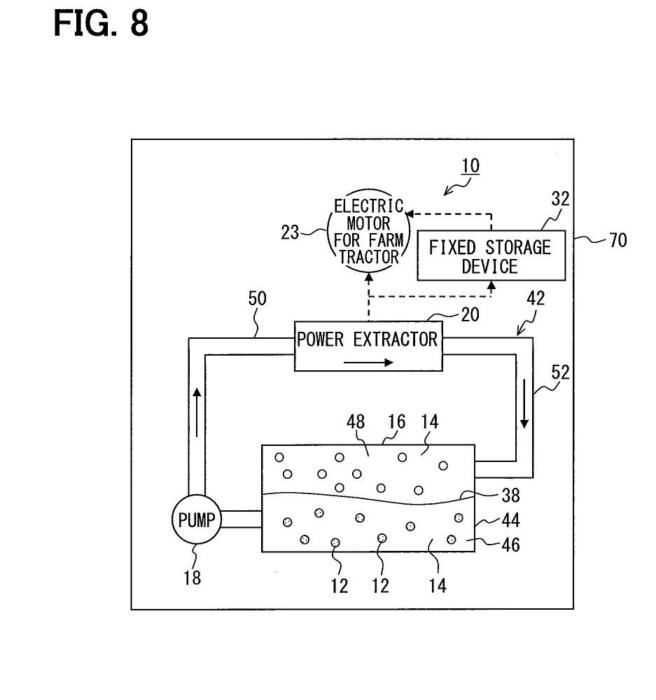

In the above-described embodiment, the bubble battery system 10 is applied to a personal vehicle. However, it should be understood to one of ordinary skill in the art that the bubble battery system 10 may be applied to commercial, recreational, and heavy-duty type vehicles. For examples, the bubble battery system 10 may be applied to a farm tractor 70, as shown in FIG. 8.

In farming applications, range anxiety prevents farmers from switching to electrically driven tractors from conventional tractors. As described above, however, the bubble battery system 10 can be recharged in a similar amount of time as the time required for the refilling of a conventional gasoline or diesel powered vehicle. Therefore, a farm tractor 70 utilizing the bubble battery system 10 can be recharged by refilling the power fluid, thereby eliminating the recharging time and range anxiety concerns of vehicles powered by conventional batteries.

Moreover, the bubble battery system 10 may be applied to any device that utilizes electricity as a power source.

In the above-described embodiment, the micro-battery 12 has a spherical shape, but it should be understood to one of ordinary skill in the art that the micro-battery 12 may have a shape other than a spherical shape. For example, the micro-battery 12 may have an oval shape.

In the above-described embodiment, the electric power is wirelessly transferred between the micro-battery 12 and the power extractor 20 through the first power transfer 28 and the second power transfer 54. However, it should be understood to one of ordinary skill in the art that the electric power may be conductively transferred through a physical electrical connection between the micro-battery 12 and the power extractor 20.

In the above-described embodiment, the power extractor 20 has a cylindrical shape and extends linearly along a flow path of the power fluid. However, the power extractor 20 may not be limited to this configuration. For example, the power extractor 20 may have a polygonal tubular shape or a curved cylindrical shape providing a curved flow path for the power fluid.

Further, in the above-described embodiment, the pump 18 is provided on an upstream side of the power extractor 20. Alternatively, the pump 18 may be provided on a downstream side of the power extractor 20 or on both upstream and downstream sides of the power extractor 20.

What is claimed is:

1. A bubble battery system comprising:
a plurality of micro-batteries storing electric power;
fluid media immersing the plurality of micro-batteries;
a tank storing the fluid media and the plurality of micro-batteries;
a power extractor fluidly connected to the tank and extracting the electric power that is stored in the plurality of micro-batteries while the fluid media and the plurality of micro-batteries flow through the power extractor; and
an electric load electrically connected to the power extractor and powered by the electric power extracted by the power extractor.

2. The bubble battery system according to claim 1, further comprising:
a first power transfer disposed in each of the plurality of micro-batteries and transferring the electric power stored in each of the plurality of micro-batteries; and
a second power transfer disposed on the power extractor and receiving the electric power transferred from each of the plurality of micro-batteries by the first power transfer.

3. The bubble battery system according to claim 2, wherein the plurality of micro-batteries is rechargeable.

4. The bubble battery system according to claim 3, further comprising:
an external power source electrically connected to the second power transfer and providing external electric power, wherein
the second power transfer transfers the external electric power supplied from the external power source, and
the first power transfer receives the external electric power transferred from the second power transfer.

5. The bubble battery system according to claim 2, wherein
the first power transfer and the second power transfer wirelessly transfer the electric power.

6. The bubble battery system according to claim 5, wherein
each of the plurality of micro-batteries includes a first alignment part, the power extractor includes a second alignment part, and the first alignment part and the second alignment part magnetically attract each other, and
when the first power transfer is aligned with respect to the second power transfer, the electric power stored in the plurality of micro-batteries is transferred to the power extractor.

7. The bubble battery system according to claim 1, further comprising:
a separator within the tank that divides an inside space of the tank into a powered space and a depowered space, wherein
the powered space stores a plurality of charged micro-batteries and the depowered space stores a plurality of discharged micro-batteries.

8. The bubble battery system according to claim 7, wherein
the separator has a permeable membrane that allows the fluid media to flow between the powered space and the depowered space.

9. The bubble battery system according to claim 7, wherein
the powered space is refillable with the plurality of charged micro-batteries, and
the depowered space is emptyable of the plurality of discharged micro-batteries.

10. The bubble battery system according to claim 1, wherein
the electric load is a motor for a vehicle.

11. The bubble battery system according to claim 10, wherein the vehicle is at least one of a commercial, a recreational, or a heavy-duty vehicle.

12. The bubble battery system according to claim 1, further comprising:
an energy storage device electrically connected between the power extractor and the electric load, wherein
the energy storage device absorbs electric surge between the power extractor and the electric load.

13. The bubble battery system according to claim 1, further comprising:
a refilling device storing the plurality of micro-batteries, the refilling device fluidly connectable to the tank, wherein
the refilling device refills the tank with the plurality of micro-batteries.

14. The bubble battery system according to claim 9, further comprising:
a refilling device fluidly connectable to the tank, the refilling device including
a first container storing the plurality of charged micro-batteries, and
a second container storing the plurality of discharged micro-batteries, wherein
the refilling device transfers the plurality of discharged micro-batteries from the depowered space to the second container and refills the powered space with the plurality of charged micro-batteries from the first container.

15. The bubble battery system according to claim 14, further comprising:
an external power source electrically connected to the refilling device and providing external electric power, wherein
the refilling device charges the plurality of discharged micro-batteries that are stored in the second container using the external electric power supplied from the external power source.

16. The bubble battery system according to claim 1, further comprising:
an external power source providing external electric power; and
a wireless power transmitter electrically connected to the external power source and positioned externally adjacent to the fuel tank, wherein
the wireless power transmitter wirelessly charges the plurality of micro-batteries in the fuel tank using the external electric power supplied from the external power source.
